(19) United States
(12) Patent Application Publication
(10) Pub. No.: US 2007/0239838 A1
(43) Pub. Date: Oct. 11, 2007

(54) Methods and systems for digital content sharing

(76) Inventors: James P. Laurel, Woodinville, WA (US); Michael H. Laurel, Bellevue, WA (US); Serena Glover, Redmond, WA (US); Don Kim, Lynnwood, WA (US); Philip F. Carmichael, Woodinville, WA (US); Randall L. Kerr, Edmonds, WA (US)

Correspondence Address: DWC LAW FIRM, P.S., P.O. BOX 3041, SEATTLE, WA, 98114-3041, US

(21) Appl. No.: 11/786,056

(22) Filed: Apr. 9, 2007

Related U.S. Application Data
(60) Provisional application No. 60/791,024, filed on Apr. 10, 2006.

(51) Int. Cl. G06F 15/16

(52) U.S. Cl. 709/206; 709/232

(57) ABSTRACT

In some embodiments, computer-implemented methods are provided to allow users to store electronic files in a central repository accessed over a network. The stored files are associated with the users and can be associated with particular channels established using a server based application. The channels can designate parties that have access thereto. Users can control settings related to the channels. The users can also transmit electronic files to the channels by email and can also control actions taken by the server with respect to the electronic files using commands in the email. Systems are provided for carrying out the computer-implemented methods.

### CROSS-REFERENCE TO RELATED APPLICATION(S)

This application claims the benefit of U.S. provisional patent application Ser. No. 60/791,024, filed Apr. 10, 2006, which is incorporated herein by reference in its entirety.

### BACKGROUND OF THE INVENTION

1. Field of the Invention

The present invention relates to an electronic file sharing system and method for use in sharing electronic files over a network.

2. Description of Related Art

The sharing of digital content is widespread and popular and used in a plethora of contexts, for business, for pleasure and for other personal reasons. In business, it can be said to be a necessity in our time. In personal life, sharing digital content over the Internet is a natural part of everyday life for many, and can sometimes be the only cost-effective means of sharing media with family and friends from far away. However, despite the pervasive sharing of digital content, and even its growing necessity, many users would likely assert that the available means for sharing still leave much to be desired.

For example, the predominant means for sharing is by email, which can often be a slow and tedious process when faced with fast-paced needs. Even after the correct attachment is located and properly attached to an email, some attachments can be too large for some mail systems to handle; attaching a large number of files to an email is tedious, and is disallowed by some mail systems, requiring either the drafting of multiple emails or the additional step of compressing the files into a single archive, which the recipient must later decompress; sorting out content sent with emails and organizing it can take too much time, if it is done at all; and resending content to others is slowed down tremendously when sorting out what to send beforehand, which can lead to simply forwarding an email even if it might contain some inappropriate content. Thus, despite the commonly recognized value of sharing content via email, it can be arduous. These are just a few of the drawbacks of current means for sharing digital content by email, and other means are similarly limited by inflexibility and inconvenience. There is a need for a convenient and flexible method and system for sharing a variety of digital content that overcomes the drawbacks of current systems and provides a framework for ongoing use that is adapted to both business use and everyday life.

### BRIEF SUMMARY OF THE INVENTION

Some embodiments of the present invention comprise methods and computer implemented methods for sharing electronic files among a plurality of parties through a network, such as, without limitation, the Internet. A server can be provided that is coupled to one or more memory devices or systems, which may collectively serve as a repository for electronic files. The methods can comprise storing a plurality of electronic files in the repository and associating each of the electronic files with a registered user, with additional registered users also having additional associated electronic files stored in the repository. Each of the electronic files can be uploaded to the repository over the network remotely. Any particular electronic file can be automatically associated with a registered user who uploads the particular electronic file to the repository.

Also, each registered user can establish one or more channels, through, for example, use of a server-based application, wherein the channels are selectively associated by a registered user with one or more of the electronic files uploaded by the registered user.

The channels can also be configured by the registered user to allow other users to remotely access the channels on the server, in order to access the electronic files associated therewith. Access can include, without limitation, viewing electronic files associated with the channel through a graphical user interface. The graphical user interface can be provided, in whole, or in part, by an application running on the server, which is accessible remotely by other users. A channel can be designated to be accessible only by select users, as may be designated by the user that established the particular channel, in which case, the channel can be said to be a “private” channel. Also, in other embodiments, a particular channel can be designated by the user who established the channel, to be a “public” channel, in which case, the public channel may be accessible by all registered and unregistered users of the server.

In some embodiments of the present invention, a graphical user interface is provided having a plurality of aspects, to allow the various users, registered and unregistered, to view or access electronic files associated with certain channels. The graphical user interface can include aspects that display visual representations of electronic files and channels, such as, without limitation, thumbnail depictions of electronic files. For example, a plurality of thumbnail depictions can be displayed through the graphical user interface to a party, wherein each of the thumbnail depictions may represent a channel of a registered user. A user with access to a particular channel, which is viewing a thumbnail depiction corresponding to the particular channel, can “point and click” on the thumbnail depiction to access the channel with which it corresponds. Thereafter, the party may also view or access other electronic files associated with the particular channel.

In some aspects of the present invention, a user that established a channel can selectively designate other users with rights to carry out transactions that affect the channel, such as, for example, contributing electronic files to be associated with the channel, or moderating the channel, such as by, for example, having the ability to delete electronic file associations with the channel, or to designate additional other parties with viewing rights for the channel.

In some additional embodiments of the present invention, users can email electronic files using an Internet format email address, which are then associated with a channel. That is, for example, a user can attach an electronic file to an email and send it to an Internet format email address, which is received and recognized at the server as being associated with a particular channel or a new channel to be created at the server. The electronic file can be then be automatically stored at the repository of the server and associated with the particular channel after which, those parties or users having access rights to the channel, can remotely access the emailed electronic file through a graphical user interface deliverable by the server over the network.

In further embodiments of the present invention, users, such as registered users of the server, can also send commands to the server via email which are recognizable by a server based application of the present invention as commands to execute one or more functions. The functions can include, among other things, designating one or more parties with access rights to a channel, associating geographical location information with an electronic file, and associating keywords with the electronic files, usable for searches to allow others to search for the electronic file on the server.

In other embodiments of the present invention, systems for carrying out various embodiments of the present invention are also provided. The systems can comprise a server configured to allow users to store electronic files, to create and configure channels as described, and to associate email addresses with the channels to allow users to remotely contribute electronic files to channels.

### BRIEF DESCRIPTION OF SEVERAL VIEWS OF THE DRAWINGS

FIG. 1 is a block diagram of a system comprising user devices and a network for use in implementing various embodiments of the present invention.

FIG. 2 is a diagram illustrating virtual repositories associated with registered users (parties), or members, of a network community for an embodiment of the present invention, with each virtual repository being defined by associations between user-identifications and electronic files stored in a physical repository.

FIG. 3 is an association diagram for some embodiments of the present invention, showing relationships between channels, user-identifications and electronic files in a first party user's virtual repository.

FIG. 4 is an overview diagram illustrating available selections that a first party can make in granting access (e.g. viewing), contribution and moderator rights to others in some embodiments of the present invention.

FIG. 5 is an example aspect of a graphical user interface for use with some embodiments of the present invention, showing a plurality of visual identifiers representing channels of second parties (i.e., other registered users) from a first party's perspective.

FIG. 6 is another example aspect of a graphical user interface for use with some embodiments of the present invention, when selecting various links or commands.

FIG. 7 is another example aspect of a graphical user interface for use with some embodiments of the present invention for configuring a channel or adjusting settings for a channel.

FIG. 8 is another example aspect of a graphical user interface for use with some embodiments of the present invention depicting a plurality of visual identifiers all associated with a first party user's plurality of channels, with links or icons for launching or accessing commands being displayed adjacent each visual identifier.

FIG. 9 is an example embodiment of the present invention showing some of the possible combination of steps taken by a first party in sharing an electronic file to a second party.

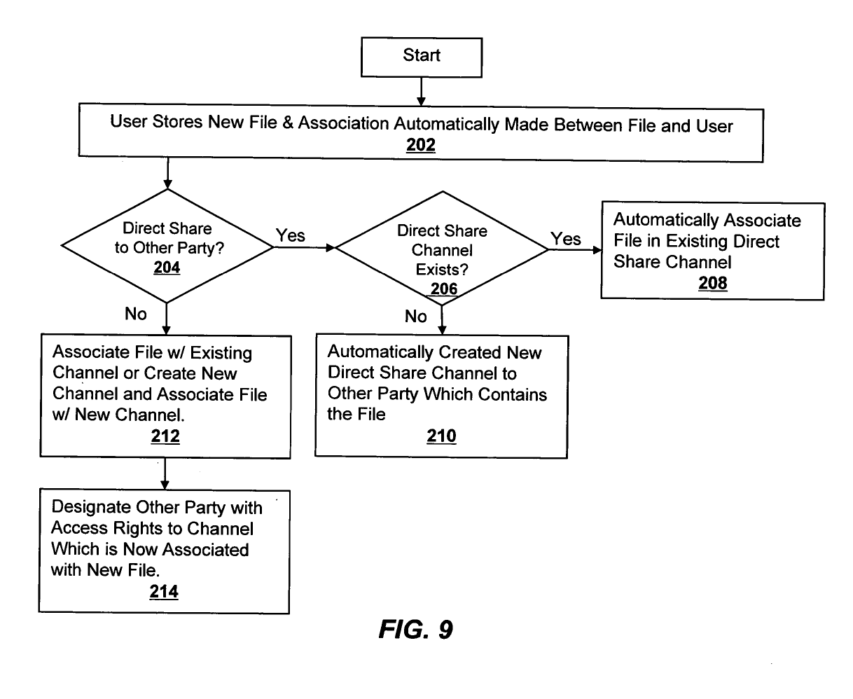

FIG. 10 is an example embodiment of the present invention showing one of various possible combinations of steps taken by a first party in storing an electronic file by electronic mail.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available hardware, software and network infrastructures have not been described in detail to avoid unnecessarily obscuring the descriptions of the embodiments of the invention.

Where section headings are provided below, they are provided only for clarity to the reader and are not intended to limit the content disclosed herein.

The term “electronic files,” as used herein, can include, without limitation, image, text, video, audio or multimedia files, or units of digitally stored information of any type. Throughout various portions of this disclosure, various users are referred to as “registered” and “unregistered,” to respectively signify users who have been assigned user-identifications recognizable by a server-based application and those who have not. The term “first party” is used herein to refer to a registered user, and other registered users (other than the first party) can each be referred to as a “second party,” or collectively as “second parties,” unless the context indicates otherwise.

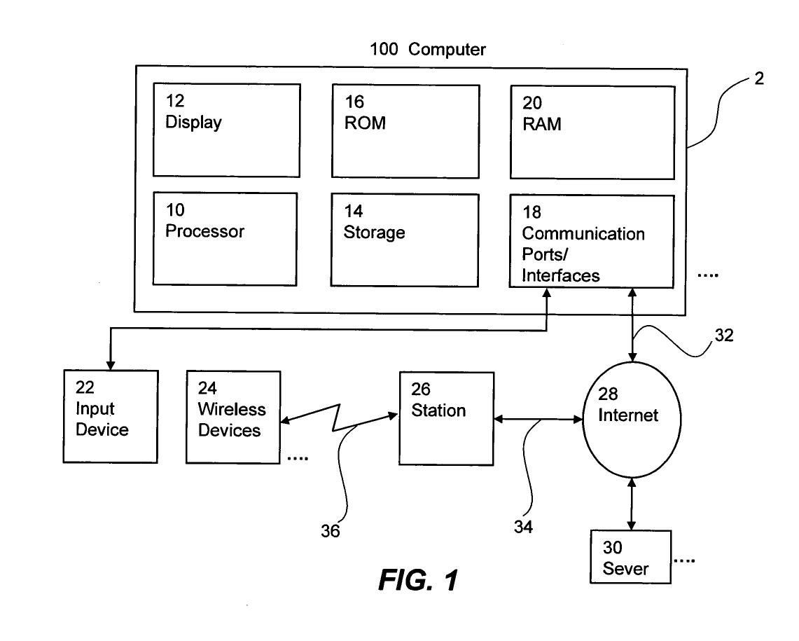

Referring to FIG. 1, various embodiments of the present invention can include an electronic file sharing system 2, hosted by one or more servers 30 and can be remotely accessible over a global network 28 (e.g., the Internet), a local area network, or wide area network, or a combination thereof by a plurality of clients. The server 30 can comprise one or more computers, or other devices or systems capable of processing instructions and information and communicating over the network 28. As will be appreciated by those skilled in the art after reviewing this disclosure, users, or parties, can become registered by providing information to a server-based application, that is, in turn, associated with specific user-identifications.

FIG. 1 further shows one or more computers 100 communicatively coupled to a server 30 via the global network 28. One or more wireless telecommunications devices 24 can also be linked to the server 30, such as, for example, by a wireless data network 36 that is communicatively coupled to the Internet through a station 26, which demodulates the wireless signals. The wireless devices 24 can be cellular telephones or other telecommunications devices configured for use in long-range or short-range wireless networks.

Each computer 100 can include a processor 10, display system 12, non-volatile storage device 14, ROM 16, a plurality of communications ports 18 and communications interfaces, and RAM 20. The plurality of communication ports 18 on computer system 100 can receive control signals from input devices 22 (e.g., keyboard or mouse) and various communications interfaces can be provided to enable communications over the network 28.

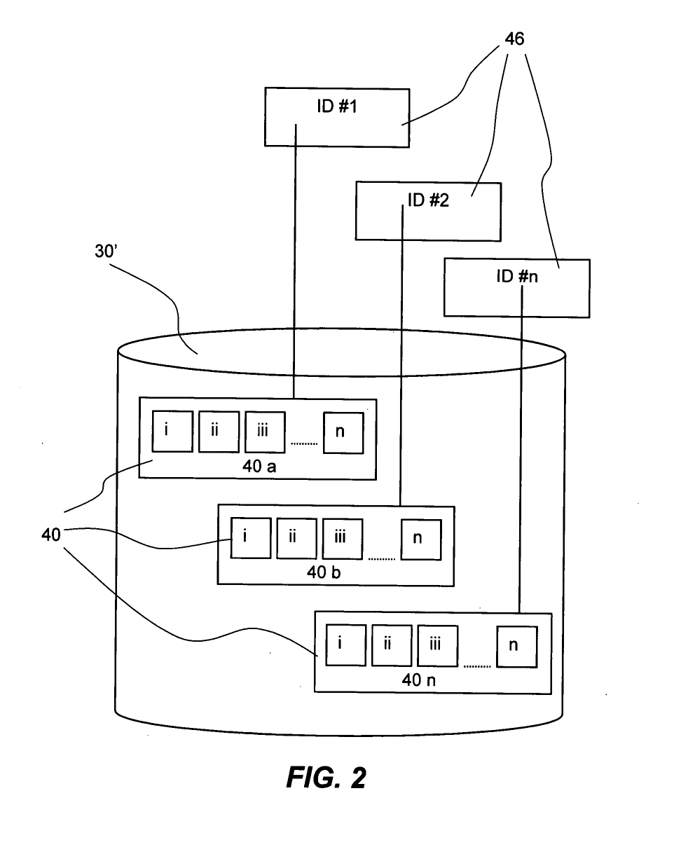

FIG. 2 shows an example aspect of a file association structure used in some embodiments of the present invention wherein electronic files are stored in a repository 30′. The repository 30′ can be communicatively coupled to server 30. The illustrated file association structure comprises associations between each of the stored electronic files, i, ii, iii . . . n, and a corresponding user-identification 46 (user-identifications 46 are represented in FIG. 2 as ID#1, ID#2 and ID#n, for illustrative purposes), thereby defining virtual repositories, 40a, 40b . . . 40n, each associated with a particular registered user. The associations between the stored electronic files and user-identifications 46 can be automatically established when, for example, a registered user having a user-identification ID#n, is acknowledged by the server via client communication with the server, and thereafter uploads an electronic file to the server 30. In other aspects of the present invention, associations in virtual repositories 40 can be designated by instruction to the server 30 provided manually or by other automated features, as will be appreciated by those skilled in the art after reviewing the present disclosure.

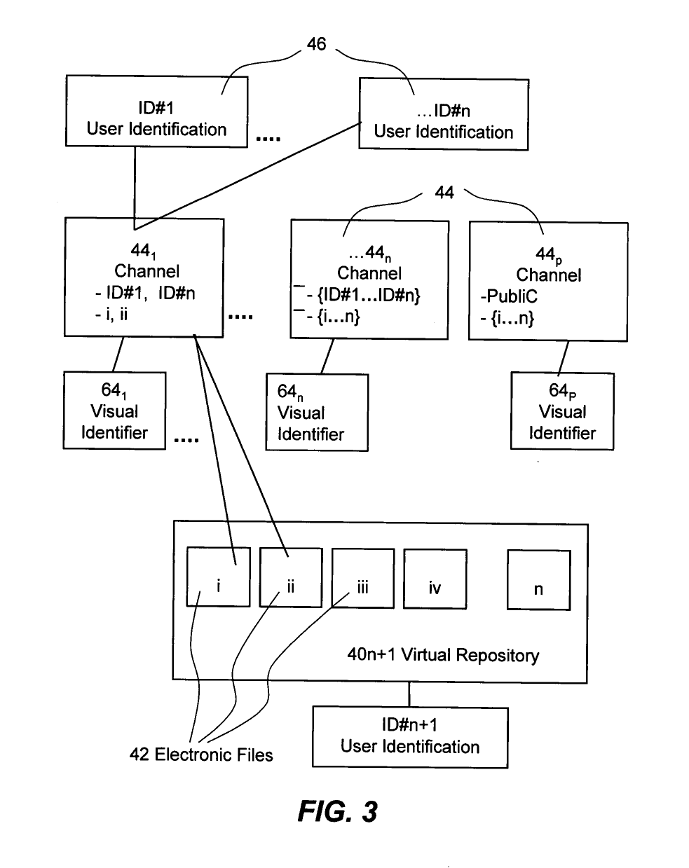

In FIG. 3, an example virtual repository 40n+1, belonging to a first party user ID#n+1, is shown, having a plurality of electronic files 42 (comprised of i, ii, iii, iv . . . n). In some embodiments of the present invention, one or more “channels” 44 can be associated with one or more of the electronic files 42 in the virtual repository 40n+1. As those skilled in the art will appreciate after reviewing this disclosure, the term “channels” can refer to, without limitation, configurable and storable queries having associated access rights for accessing electronic files, the queries designating which parties have rights to act on the queries, with the queries being adjustable. The channels can also be, for example, virtual containers with associated data for controlling access by parties to one or more electronic files associated with the containers, wherein the associated electronic files can be selectable. For example, channel 44₁ in FIG. 3 has been selectively configured to be associated with electronic files i & ii. Also, as each channel 44 can designate one or more users with access rights, the example channel 44₁ is illustrated in FIG. 3 as being associated with second party users having user-identifications ID#1 and ID#n. Thus, in this example embodiment, channel 44₁ permits second party users ID#1 and ID#n to access or view electronic files i & ii in virtual repository 40n+1 belonging to registered user ID#n+1. The second party users in this example are registered users.

As will be appreciated by those skilled in the art after reviewing the present disclosure, any number of channels 44n, may exist in relation to the first party's virtual repository 40n+1, by being either directly or indirectly created and configured by the first party user ID#n+1. In some aspects of the present invention, only designated second party users, as designated in the channel 44n, may launch the channel 44n to query for the associated electronic files. In further embodiments of the present invention, no user may access any electronic file contained within a first party's virtual repository, except through use of a channel of the first party with which the electronic file has been associated.

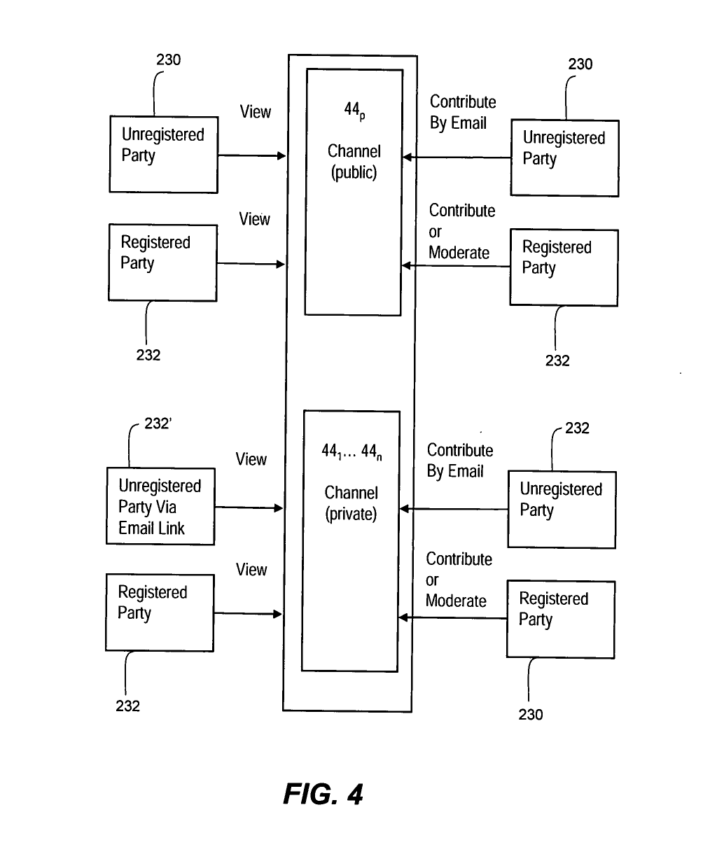

In various embodiments of the present invention, unregistered users (e.g., those who access certain features or aspects of software provided on server 30, as may be selectively granted by instructions residing at the server) may also be designated with access rights to various channels 44. For example, a first party user may designate “public” access in relation to a channel, such as channel 44ₚ in FIG. 3, such that unregistered users in communication with the server 30 through the network 28 may view or access electronic files associated with the public channel 44ₚ. Also, in some embodiments of the present invention, a first party user may email a link, such as an active connection to a web page hosted on the server 30, to an unregistered party, wherein the link can provide access for a channel 44, public or private, through an online graphical user interface. FIG. 4 illustrates an overview, showing, among other things, parties that can be granted access for viewing a first party user's channel 44 contents or electronic files associated therewith.

In some aspects of the present invention, the first party user selectively configures channels 44, while in other aspects, channels 44 can be automatically generated as a result of transactions between the first party and others, as will be described in further detail below.

It will therefore be recognized by those skilled in the art after reviewing this disclosure that in various embodiments of the present invention, channels 44 are usable for selectively enabling the viewing, access or sharing of electronic files between a first party user and second party users and unregistered users over network 28. On the network, there can be any number of first party users, who themselves, are second party users in relation to other first party users.

Referring again to FIG. 4, in some embodiments of the present invention, the first party user can also designate contribution rights to select second parties (i.e. registered parties), all second parties, unregistered parties, or a combination thereof. Contribution rights can include allowing other registered users to associate electronic files from their virtual repositories with a channel 44 of the first party registered user, or to otherwise provide electronic files to a virtual repository 40n+1 of the first party user, in order to associate the provided electronic files with the channel 44 for which they have contribution rights. Granting contribution rights to unregistered parties can be implemented in various embodiments of the present invention by allowing unregistered parties to email electronic files to the server 30 for association with the channel. Granting contribution rights can also be implemented through a graphical user interface, by which the first party can, for example, be displayed a visual representation of a channel 44 associated with the first party user's account, for use in selectively designating registered second parties with contribution rights to the channel, or for selecting a command to instruct the server to allow emailed electronic files from unregistered parties to be associated with the channel 44 (Described further, infra).

As shown in FIG. 4, in some embodiments of the present invention, a first party user can designate a second party with moderator rights to a channel 44 of the first party. Moderator rights include contribution rights to a channel, as well as access rights to view the channel 44. Moderator rights can also include the right to configure certain aspects of the channel 44, including, deleting electronic files from the channel; granting access to other second parties for viewing the channel; removing electronic files from the channel; inviting others to the channel, whether private or public; approving contributions by other second parties; selectively granting others with contribution rights; and otherwise managing channel participants (second parties and registered users who have access rights and contribution rights). Moderators can also add keywords to electronic files in a channel for the purposes of allowing others to search for the file, and can select which others can comment or notate on electronic files.

A graphical user interface (“GUI”) can be provided for various embodiments of the present invention, and various example aspects are now described. However, one skilled in the art will appreciate after reviewing this disclosure that a wide variety of combinations of elements for GUI 62 can be provided for carrying out a plurality of embodiments of the present invention, and the example aspects are described and presented for illustrative purposes, without limitation. Some aspects of the GUI 62 may be enabled by instructions stored on a memory of the viewing user's computer 100 or wireless device, while other aspects may be enabled through instruction executed at the server 30, or a combination thereof.

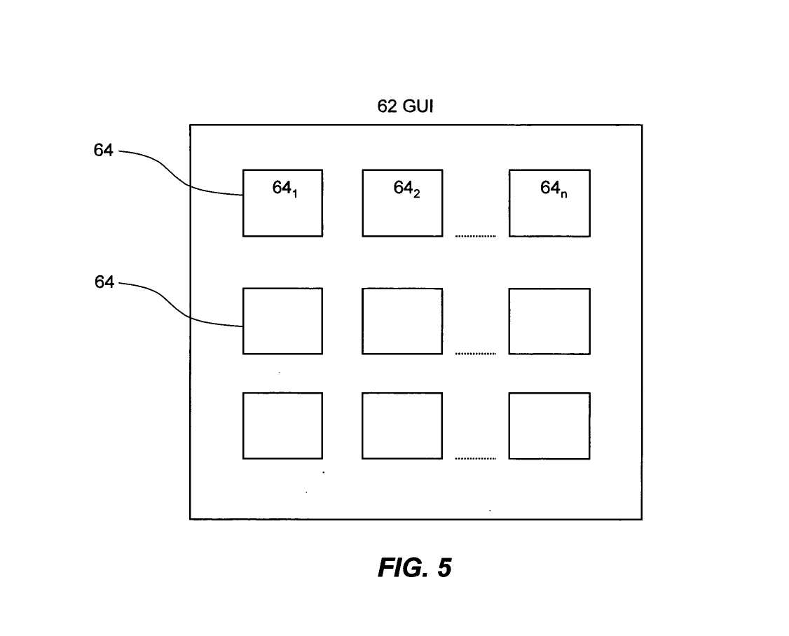

One aspect of the GUI 62 involves the display of visual identifiers 64, such as shown in FIG. 5, where a first party can view visual identifiers 64 corresponding to channels 44 of other registered users. Each visual identifier 64 can be, for example, a thumbnail depiction of an electronic file 42 (when the electronic files 42 are image files) associated with a corresponding channel 44. In other embodiments of the present invention, some visual identifiers 64 comprise combinations of a thumbnail, text or other identifying indicia. Each visual identifier 64 can be displayable to registered users, to unregistered users, or a combination thereof through various aspects of the GUI 62. The availability of a visual identifier 64 to a particular party can be a function of, or otherwise depend on, whether the corresponding channel 44 (that which is associated with the visual identifier 64) designates access rights to the viewing party, or is otherwise a public channel. That is, in some embodiments of the present invention, a given visual identifier 64 is only displayable to an unregistered user, when a corresponding channel 44 designates access rights thereto.

When a visual identifier 64 is made visible to a user, access to the content or electronic files of a channel 44 can be initiated by selecting the visual identifier 64 using a cursor controller, such as a mouse. Thereafter, the user accessing the channel can view various content or electronic files associated with the channel within another aspect of the GUI 62.

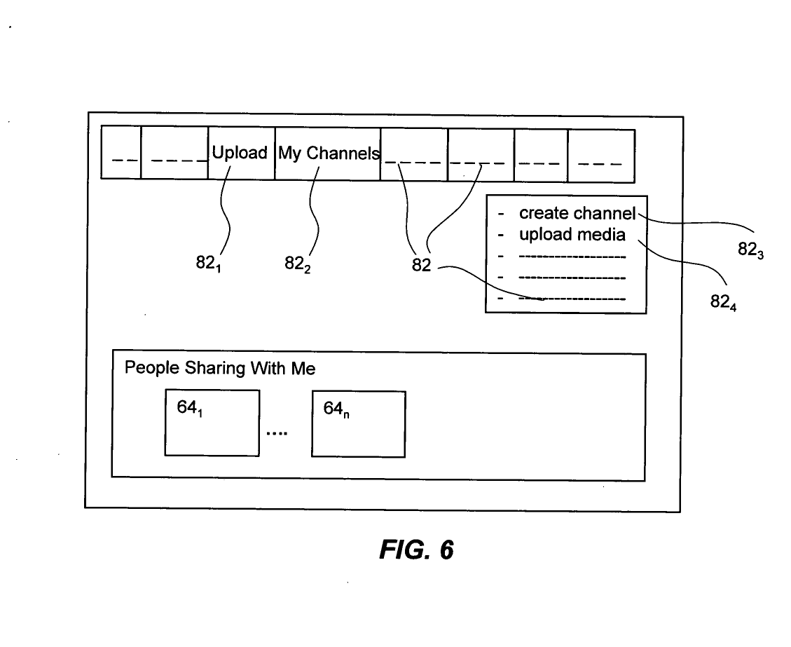

FIG. 6 shows an aspect of the GUI 62 for some embodiments of the present invention in which a first party user can use a cursor controller to select one of a variety of link indicia 82, such as “create channel” 823₁ which can cause a page, or aspect of the GUI 62, to be displayed for use in creating and configuring a channel 44, or “upload media” 82₄, which can cause a page, or aspect of the GUI 62 to be displayed that provides graphically represented tools for allowing the first party user to transfer electronic files to repository 30′ for storage therein in association with the first party's virtual repository 40ₙ₊₁.

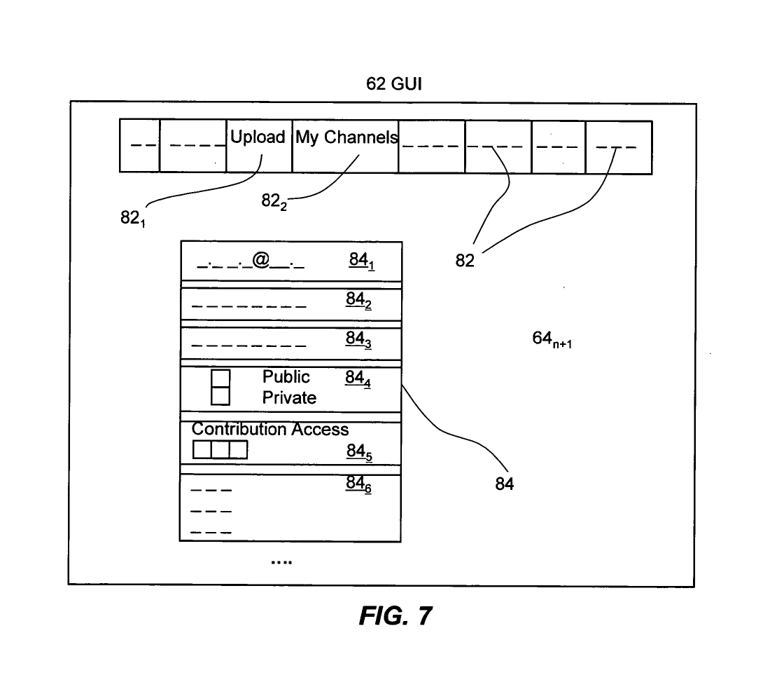

FIG. 7 shows an aspect of the GUI 62 that is displayable for setting or configuring a channel's characteristics. In the illustrated example aspect, setting fields 84 are provided and can include an address field 84₁, where the first party user can configure or assign a primary email address specific to the channel 44. Fields 84₂ & 84₃ can be used to enter descriptive information or text for display as part of the visual identifier 64 for the channel, as described previously. Field 84₄ can be used to select whether the channel being configured is for public access or private access. Field 84₅ can be used to select parties that will have contribution rights for the channel being configured (such as those parties shown in FIG. 4), and to configure or set an alternate email address for the channel, to which unregistered users or second parties can send electronic files for association with the channel, as described in more detail in the Email Commands section below. Field 84₆ can be used to select whether and which parties can modify, notate or comment on electronic files in the channel.

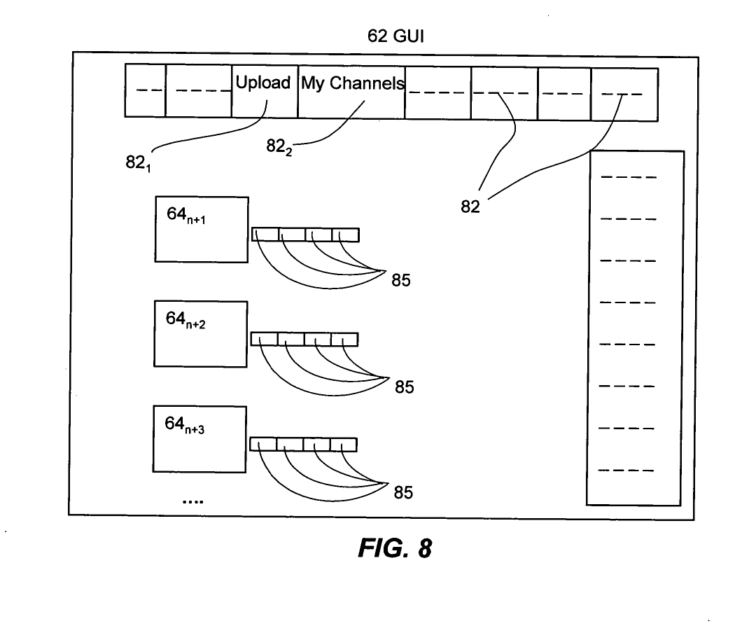

FIG. 8 shows another aspect of GUI 62 for use by a first party user in taking various actions with respect to the first party's channels 44. Visual identifiers 64₁-64ₙ representing individual channels 44 of the first party, are displayed adjacent to link indicia 85, with each link indicia 85 being linked to a different aspect of the GUI 62 for taking a different action with respect to the adjacently represented channel. The link indicia 85 can include indicia related to “upload media,” which may link to a page for uploading electronic files to the adjacent channel; “settings,” which may link to a page for selecting channel settings for the adjacent channel (like those provided by fields 84, as shown and described above for FIG. 7; “share,” which may link to a page providing fields for the first party to use to designate other registered users with access to the adjacent channel, or to enter email addresses of unregistered parties to which a link to the adjacent channel can be sent to grant access for viewing the adjacent channel; and “participants,” which can link to a page in which the first party can control settings related to a second party's participation level for the adjacently represented channel, such as whether the second party has authority to view, contribute or moderate the channel.

As those skilled in the art will appreciate after reviewing this disclosure, the visual identifiers 64 for a first party's channels that are displayable to second party registered users, or unregistered users, can be displayed selectively through various aspect of GUI 62 based on, in part, queries executed by the respective users, such as, without limitation, searches for electronic files, specific requests to view a first party user's electronic files, or to access a first party user's channel through browsing data on the server 30.

In various embodiments of the present invention, channels can also be automatically generated when a registered user engages in sharing an electronic file with another registered user directly from the registered user's virtual repository 40, without the electronic file being pre-associated with a channel. For example, in one aspect of the GUI 62, a first party user can view one or more electronic files within the user's virtual repository 40, then select one or more files and enter a second party user's identification in a provided field (not illustrated), to allow the second party user to view those files. In this “direct sharing,” a new channel 44 is automatically created designating access rights to the second party to whom the share is directed, and also associating the selected electronic files with the newly created channel. Subsequent direct sharing between the first party user and that particular second party user will be automatically associated with the same channel.

In some embodiments of the present invention, electronic files can be transmitted to repository 30′ from remote devices, such as computer 100, or wireless communications device 24 (e.g., cellular telephone, or personal digital assistant) using electronic mail by way of, for example, widely available email clients, standardized transfer protocols, and wireless data networks. The email address can be an Internet format email address and can include a recipient and domain component, with the recipient component identifying a particular channel 44 of the registered user. That is, each channel can have a globally unique email address, to which first party registered users can send electronic files as attachments to be stored and associated with both the first party's virtual repository 40 and a particular channel 44. In other alternative embodiments of the present invention, each virtual repository can have a unique email address to which a first party user can email electronic files for storage in association therewith, without specifying a particular channel.

For example, in some embodiments of the present invention, a primary email addresses for a particular channel 44 can comprise the following form, in which the [User Name] is a log-in name for a first party registered user, the [Name of Channel] is a name that can be selected by the first party registered user, which may be displayable to other parties, and the [Secret Word] is a word that will not be displayed to second parties via the GUI 62:
[User Name or ID].[Name of Channel].[Secret Word]@[_{———].com}

In some embodiments of the present invention, the [Name of Channel] parameter is selectable by a first party user, and can be selected while configuring a channel by, for example, using Field 84₁, shown in FIG. 7. In some embodiments of the present invention, the [Secret Word] can also be changed in a member profile page (not illustrated) of the first party user, accessible to the first party user through an aspect of GUI 62.

In other embodiments of the present invention, the first party user can establish a secondary or alternate email address for any given channel, which can be given to registered parties and unregistered parties, to allow those parties to contribute to the channel 44 via email. For example, the secondary email address for the particular channel can be in the following form, in which the [Guest Secret Word] is different from the [Secret Word] used in the primary email address for the channel, and is changeable by the first party registered user at any time to terminate contribution to the channel by other parties who have been given the [Guest Secret Word]:
[User Name or ID].[Name of Channel].[Guest Secret Word]@[_{———].com}

In some embodiments of the present invention, the secondary email address comprising the [Guest Secret Word], can be conveniently and selectively changed by a first party, or a moderator, on a settings page of the GUI 62, such as that illustrated in FIG. 7. Also, in some embodiments of the present invention, the [Guest Secret Word] is specific to a particular channel, while the [Secret Word] is global to all channels for the first party user.

In still further embodiments of the present invention, second party registered users who have contribution rights for a first party channel 44, can also email contributions to the first party channel by using an Internet email address of the following form:
[Second Party User Name or ID].[First Party User name or ID].[Name of Channel].[Second Party Secret Word] @______.com]

Thus, in such embodiments, second party users who have contribution rights do not need to have a [Guest Secret Word] to email a contribution to the first party's channel, whereas unregistered users would need a [Guest Secret Word] to contribute.

In addition, for some embodiments of present invention, electronic mail can be provided with commands, readable by a server 30 application for initiating the commands and executing functions associated therewith. The commands can include, without limitation, those shown in TABLE 1 below.

TABLE 1
Example Email Commands For Some Embodiments
of the Present Invention

| Command Type/ | |
|---|---|
| Example Format for Application | Function(s) Executed |
| Share/ | 1. Designates access rights |
| .S [user IDs and email addresses | to the parties indicated in |
| for parties to whom the channel | the share command, related to |
| is to be shared] | the channel indicated in the |
| | primary email address. |
| | 2. Sends notification to each |
| | party indicated by the sender |
| | in the Share command, including |
| | email notifications to the email |
| | addresses provided with the |
| | Share command, and notifications |
| | to registered users. |
| Description/ | Associates the text provided |
| .D [user provided text] | with the electronic file sent, |
| | such as, for example, by |
| | displaying a description field |
| | with a digital image electronic |
| | file when it is accessed |
| | through the GUI 62. |
| Message/ | Sends a message provided by a |
| .M [user provided message] | user with the notification |
| | described above for the Share |
| | command, such as, for example, |
| | a short sentence asking the |
| | recipient of an email to |
| | visit a particular channel. |
| Create New Channel/ | The use of .N creates a new |
| .N [p] | channel, and automatically |
| | associates the uploaded |
| | electronic file with the |
| | new channel. The use of the |
| | letter “p” after the .N |
| | command, designates the newly |
| | created channel as a private |
| | channel, otherwise, the new |
| | channel will be a public channel. |
| Keywords/ | Associates keywords with the |
| .K [keywords separated by | electronic file being uploaded |
| delineators, such as spaces, | for use in keyword searches |
| commas or semicolons. | over via the server 30, which |
| Composite keywords can be | may call up the electronic file. |
| enclosed in quotes.] | |
| Location/ | Associates an electronic file |
| .L [zip code, place name, | with a geographic location, |
| street address, city | which can be displayed when |
| and/or country, etc.] | the electronic file is accessed, |
| | including displaying a graphical |
| | map image of the associated |
| | location information. |

Referring to TABLE 1, the “Share” command allows a first party user to share an email attachment to registered and unregistered parties. That is, for example, a first party user can attach an electronic file (or a plurality thereof) to an email and send the electronic file to a primary email address designating a channel 44 of the first party user. In addition, the addresses listed in the share command can also receive a notification from server 30 with a link to a page for accessing the electronic file, and the address can be an external email address that is not associated with server 30. Also, if an ID of a registered user is provided, which is not already designated in the channel to which the electronic file is being sent, that registered user can be automatically designated into the channel, such that the registered user will have access to all electronic files previously associated with the channel. Also, in other alternative embodiments of the present invention, the address to which the email is sent can identify only a virtual repository 40 of the first party without identifying an channel, in which case, one can be automatically created, and can designate any parties in the Share command line with access rights, and associating the attachment with the newly and automatically created channel.

When the “Location” command is used, in some embodiments of the present invention, data is associated with the electronic file attachment when it is stored at repository 30′. Thereafter, when it is accessed, such as a digital image being viewed, the location data can also be processed at server 30 for use in displaying a graphical map image, as will be appreciated by those skilled in the art after reviewing this disclosure. The graphical map image can illustrate the location, such as, for example, by displaying a visual pointer pointing to a specific city on a map of the United States, or a State or county in which the city resides, or to a particular address within an image showing a portion of a city. In various embodiments of the present invention, whether the graphical map image is displayed is dependent on selections chosen by the viewer.

In further embodiments of the present invention, the server 30, or server based-application residing thereon, tracks transactions between registered users and outside email addresses not associated with the server. When previously unregistered users provide email addresses via registration with the server 30 or registered users associate email addresses with their registration IDs, the server can automatically associate rights previously granted through those tracked email addresses to the IDs of newly registered users or registered users. For example, if a first party previously shared a channel 44 via an email link to an unregistered user, and the previously unregistered user provides that email address when registering with server 30, the server automatically associates an ID of the newly registered user with any channel rights previously granted through that email address. This can include, for example, without limitation, a channel access right emailed to the previously unregistered user (e.g., a link to the channel, as previously described).

### EXAMPLE USES

Presented below, for illustrative purposes, are various example uses of the present invention.

### Example use #1

In one example embodiment of the present invention, a first party user desires to share a new electronic file with another party, privately and without sharing the electronic file with other users in any pre-existing channels. As best seen in FIGS. 2, 3 & 9, the first party user stores the new electronic file 42 in a repository 30′ and the new electronic file 42 is automatically associated with the first party user, step 202, as part of the first party user's virtual repository 40n+1. The first party user may elect to engage in “direct sharing” with the other party, step 204, and take action to do so in accordance with various embodiments of the present invention previously described. If a direct share channel from the first party user to the other party already exists, step 206, then the electronic file 42 is automatically associated with the previously existing direct share channel from the first party user to the other party, step 208. If a direct share channel does not yet exist, a new direct share channel is created, step 210, which associates the other party with designated access rights to view content in the newly created direct share channel. In some embodiments of the present invention, direct share channels can only have one designated second party viewer, or participant, and only the first party user can contribute to the direct share channel created by the first party. In another aspect, the first party user can create a new channel 44 and associate the electronic file 42 with the new channel, or may associate the file with an existing channel, which does not yet designate any parties as participants, step 212. In.step 214, the first party user then designates the other party with access rights to the channel now associated with the new electronic file 42, which is either the newly created channel, or previously the existing channel.

### Example use #2

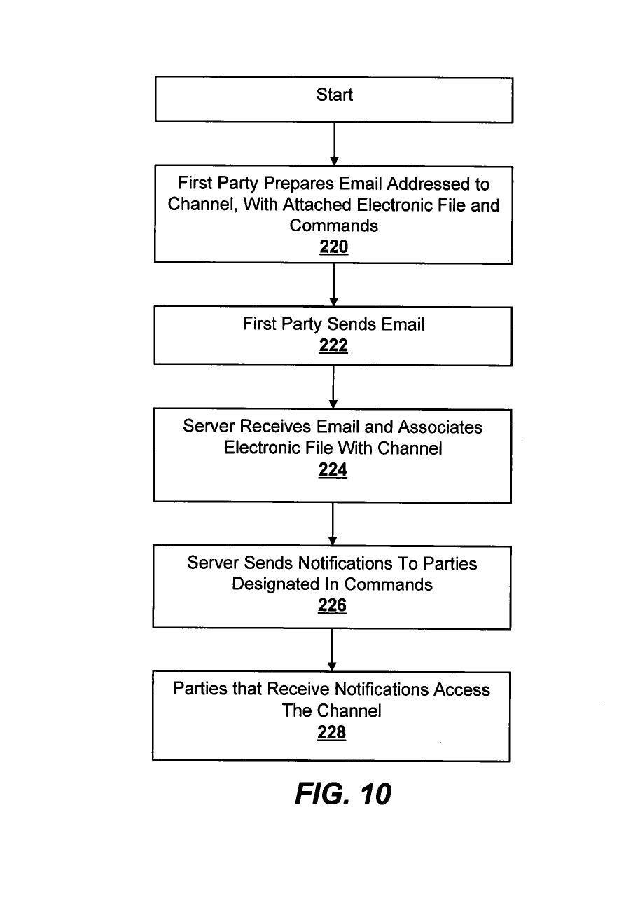

Referring to FIG. 10, in another example, illustrating use of an embodiment of the present invention, at step 220, a first party registered user uses an email client and opens a new email template and enters an email addressed to one of the registered user's channels 44. The address is the form of, for example, “John.TravelChannel.First@[_{———}].com,” where “John” is a user's ID, “TravelChannel” is a name of the channel, and “Fist” is a secret word, and “[_{———}].com” represents, for example, a second and top level domain component. The registered user attaches an electronic file to the email for delivery, such as a digital image file. In the subject line, the user types a title for the image, such as, for example, “Summer Vacation.” The registered user types commands in the body of the email, the commands including the Share command, followed by an identification of a second party registered user, as well as an email address of an unregistered party. The Share command is in the form of, for example, “.s_{———}@_{———}.com david.” The commands entered also include a Location command in the form of, for example, “.1 Rome, Italy,” and a Message command in the form of “.m hey guys, we're in Rome this summer.” At step 222, the registered user sends the email. The server 30 receives the email and associates the electronic file attachment with the addressed channel automatically, step 224. Also, the server sends an email to the email address indicated in the Share command, namely, _{———}@_{———}.com, step 226, containing a link to the addressed channel which allows the recipient of the email to access the channel to which the original email was sent. The link contained in the recipient's email displays a thumbnail depiction of the electronic file, which is a digital image. In addition, the email sent to the recipient includes the message, “hey guys, we're in Rome this summer.” At step 228, the recipient of the email from the server activates the link, and is able to view an aspect of GUI 52 and is granted viewing access to the channel, including the electronic file transmitted as an email attachment by the first party user. In addition, a graphical representation of a map is displayed to the recipient within an aspect of the GUI 62, with a pointer pointing at the city of Rome on a map of Italy. The recipient is also able to view all electronic files associated with the channel to which the email was addressed. The second party registered user also is able to access the message notification saying “hey guys, we're in Rome this summer,” via access to the server 30, and to “click” on a link shown within an aspect of GUI 62, that allows the second party registered user to view the channel to which the electronic file was sent by email.

### Example use #3

In yet another example use, a first party user can elect to send an email to either a registered or non-registered party, granting access to a particular channel of the first party user. The email can be, for example, initiated from within the graphical user interface described above. The email can include a thumb nail depiction of an electronic file (e.g., image) associated with the first party user's particular channel. The email can also include a separate active link that is not a thumbnail depiction of any particular electronic file. The thumbnail can link the recipient to a specific URL associated with a specific image represented by the thumbnail, thereby allowing the recipient to view a larger depiction of the image represented by the thumbnail when the thumbnail is selected by the recipient. The recipient can also be simultaneously link to an online aspect of the graphical user interface that allows the recipient to view other electronic files in the particular channel when linked to the specific URL. When the recipient clicks on the separate active link within the email, the recipient can be linked to an online gallery page (e.g., a gallery of thumbnails representing electronic files) within the graphical user interface hosted at the server. From the gallery page, the recipient is able to access various electronic files within the particular channel of the first party user to which the recipient has been given access.

In some embodiments of the present invention, software, or software components, are also provided for use at the remote devices on the network, such as computers and mobile electronic wireless devices, which may be configured to provide various features such as graphical user interfaces and the like on the devices, for interacting with software used to execute functions at the server 30. In some embodiments of the present invention, such software, or software components, can be provided on computer-readable mediums (such as, for example, without limitation, floppy disks, CD-ROM disks, tapes, flash memory, system memory, DVD-ROM, or hard drives), as will be appreciated by those skilled in the art after reviewing this disclosure.

Although specific embodiments and examples of the invention have been described for illustrative purposes, various equivalent modifications can be made without departing from the spirit and scope of the invention, as will be recognized by those skilled in the relevant art after reviewing the present disclosure. The various embodiments described can be combined to provide further embodiments. The described structures, systems, methods and user interfaces can omit some elements or acts, can add other elements or acts, or can combine the elements or execute the acts in a different manner or order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A computer implemented method for sharing electronic files through a network, the method comprising:
storing a plurality of electronic files in at least one repository remotely accessible over the network by a party;
associating one or more of the electronic files stored in the at least one repository with one or more channels;
configuring each of the channels to designate access rights to one or more parties; and
receiving at least one of the electronic files through electronic mail at a server with the electronic mail containing a sender written command, and executing the sender written command at the server to perform one or more functions related to the received at least one electronic file or to the one or more channels.

2. The method of claim 1 wherein each of the electronic files can be non-uniquely associated with more than one of the channels.

3. The method of claim 1 wherein at least a one of the electronic files is uniquely associated with only one of the channels.

4. The method of claim 1 further comprising automatically associating the received at least one electronic file with at least one of the channels based on an address to which the electronic mail is sent.

5. The method of claim 4 wherein there are at least two different addresses usable to automatically associate the received electronic file with the at least one of the channels, and wherein at least one of the two different addresses can be selectably changed by a user, without disassociating the address from the at least one of the channels.

6. The method of claim 1 wherein the one or more functions comprise designating access rights to at least one party for at least one channel.

7. The method of claim 1 wherein the one or more functions comprise designating access rights to a plurality of parties for at least one channel.

8. The method of claim 1 wherein the one or more functions comprise creating a new channel and associating the received electronic file with the new channel.

9. The method of claim 8 wherein the command contains instruction to the server to name the new channel in accordance with a name provided with the email, and further comprising displaying the name on a graphical user interface in association with the electronic file when an authorized query is made to the server.

10. The method of claim 1 wherein the one or more functions comprises sending an electronic notification from the server to at least one party other than the sender of the electronic mail to indicate the availability of the electronic file at the server.

11. The method of claim 10 wherein the notification is provided by electronic mail from the server to both registered users of the server and to electronic mail addresses not associated with the server.

12. The method of claim 1 wherein the one or more functions comprises associating a descriptive term with the electronic file for display to a party over the network.

13. The method of claim 1 wherein the one or more functions comprises associating location data with the electronic file and displaying the location information when the electronic file is accessed over the network.

14. The method of claim 13 wherein displaying the location information includes displaying a graphical representation of the location information.

15. The method of claim 14 wherein displaying the graphical representation of the location information comprises displaying a map.

16. The method of claim 1 wherein the one or more functions comprises associating data with the electronic file usable for searching for the electronic file.

17. A method of sharing digital content through a network, the method comprising:
providing a server communicatively coupled to the network and having a repository for use in storing electronic files;
establishing channels at the server with which the electronic files can be associated;
recognizing at the server a first email address and associating an electronic file transmitted to the first email address with a first channel, the first channel designating party access rights; and
recognizing at the server a second email address and associating an electronic file transmitted to the second email address with the first channel, and wherein a first party can selectively change at least a portion of the second email address, and wherein the server can still thereafter recognize the changed second email address and automatically associate an electronic file transmitted to the changed second email address with the first channel.

18. A system for sharing electronic files through one or more servers on a network, comprising:
a server operable for receiving an electronic file transmitted over a network in association with an email sent to an Internet email address, the Internet email address having a format comprising at least one portion that includes a user identification usable by the server for identifying a party and at least another portion that is adjustable and can be changed without impairing the server's ability to identify the party as a function of the at least one portion of the Internet email address when the email is received by the server;
a memory integral or coupled to the server for storing the electronic file; and
a processor operable to save the electronic file to the memory upon receipt of the electronic file at the server.

19. The system of claim 18 wherein the email can include text having a command which can be executed by the processor upon receipt of the command at the server.

20. The system of claim 19 wherein the command can include descriptive text for the electronic file, and wherein the descriptive text is stored in association with the electronic file at the server and can be automatically displayed to a user that accesses the electronic file through the network.

21. The system of claim 19 wherein the command can include a message and wherein the server initiates a transmission of a graphical image with the message embedded therein to a plurality of parties.

22. The system of claim 19 wherein the command includes a message and wherein the server initiates a transmission of a link with the message to a plurality of parties.

23. The system of claim 19 wherein the server includes application software for defining a plurality of channels and wherein the command includes a name for a channel which the server associates with the channel and transmits to parties that access the channel remotely.

24. The system of claim 19 wherein the command includes keywords that the server associates with the electronic file, the keywords being usable to search for the electronic file through the server.

25. The system of claim 19 wherein the command includes location information that the server associates with the electronic file.

26. The system of claim 25 wherein the server displays a graphical representation of location information to a party accessing the electronic file.

27. The system of claim 19 wherein the command affects access to the electronic file as stored in the memory.

28. The system of claim 18 wherein the particular email address affects access to the electronic file by a plurality of parties.

29. The system of claim 18 wherein the server includes application software for defining a plurality of channels, and wherein the email address is specific to a unique channel.

30. A computer implemented method of sharing electronic files over a network having a server operable for establishing channels associated with electronic files, wherein a party having access rights to a channel can access the electronic files associated with the channel, the method comprising:
storing an electronic file in a repository
associating the electronic file with a first party; and
selecting a second party to which to share the electronic file and automatically generating a new channel which designates an access right in the new channel to the second party or automatically associating the electronic file with an already existing channel in which only the second party has access rights.

31. The computer implemented method of claim 30 further comprising:
establishing an additional new channel;
associating an additional electronic file with the additional new channel; and
designating the second party to have access rights to the additional new channel.

32. The computer implemented method of claim 30 further comprising associating an additional electronic file with an existing channel in which the second party has access rights.

33. A system for sharing electronic files through a network, the system comprising:
a repository for storing electronic files;
a communications link from the repository to the network for receiving electronic files from remotely located parties;
a processor communicatively coupled to the repository and the network; and
wherein the system is configured to perform a plurality operations as may be activated by a first party user of the system, the first party user having previously registered with the system by establishing a user-identification now recognizable by the processor, the plurality of operations comprising:
associating a plurality of electronic files with a user-identification of the first party to define a virtual repository for the first party;
associating at least one of the said electronic files with one or more channels and associating the one or more channels with a user-identification for at least one second party to designate the at least one second party with access rights to the one or more channels;
providing a selectable option to the first party user for each of the one or more channels, to allow the first party to elect one or more registered parties to contribute electronic files to the channel; and
providing a selectable option to the first party user for each of the one or more channels, to allow unregistered parties to contribute electronic files to the channel.

34. The system of claim 33 wherein the operations further comprise displaying a plurality of visual identifiers to the first party in a graphical user interface, with each visual identifier corresponding to a channel, and displaying a plurality of indicia adjacent each visual identifier, wherein each of the plurality of indicia represent selectable option related to a channel corresponding to the visual identifier.

35. The system of claim 33 wherein the operations further comprise providing a selectable option to the first party user for each of the one or more channels to allow the first party user to elect one or more other third parties to moderate a channel.

36. The system of claim 33 wherein the operations further comprise displaying a field in a graphical user interface to the first party user for selecting a guest email address usable by unregistered parties for contributing electronic files to a channel.

37. The system of claim 36 wherein selecting the guest email address comprises selecting only part of a recipient portion of an Internet format email address, and wherein all other portions of the Internet format email address remain static for the channel.

38. The system of claim 37 wherein there is also a primary email address for use in contributing electronic files to the channel, and wherein the primary email address comprises a different recipient portion that differs only in part from the guest email address.

39. The system of claim 36 wherein there is also a primary email address for use in contributing electronic files to the channel.
